(19) United States
(12) Patent Application Publication
(10) Pub. No.: US 2005/0271298 A1
(43) Pub. Date: Dec. 8, 2005

(54) Noise measurement apparatus for image signal and method thereof

(76) Inventor: Pil-ho Yu, Suwon-si (KR)

Correspondence Address: STANZIONE & KIM, LLP, 919 18TH STREET, N.W., SUITE 440, WASHINGTON, DC, 20006, US

(21) Appl. No.: 11/129,285

(22) Filed: May 16, 2005

(30) Foreign Application Priority Data
Jun. 8, 2004 (KR) 2004-41929

(51) Int. Cl. G06K 9/00

(52) U.S. Cl. 382/286

(57) ABSTRACT

A noise measurement apparatus and a method thereof capable of reducing an error in measuring a noise of incoming image signals. A picture of an incoming image signal is broken into at least two blocks and an average brightness value with respect to each block is calculated in a sequence. At least two first data, each being a sum of differences between the calculated average brightness value and brightness values of respective constituent pixels of the block, where the average brightness value is calculated, and a spatial noise is calculated based on the at least two first data. At least two second data that indicate a difference a brightness value of each block of the picture and a brightness value of each block of a delayed picture is calculated, and a temporal noise is calculated based on the at least two second data. A noise on the image signal is calculated based on the spatial noise and the temporal noise.

### CROSS-REFERENCE TO RELATED APPLICATIONS

This application claims the benefit under 35 U.S.C §119 (a) of Korean Patent Application No. 2004-41929, filed on Jun. 8, 2004, in the Korean Intellectual Property Office, the disclosure of which is incorporated herein by reference in its entirety.

### BACKGROUND OF THE INVENTION

1. Field of the Invention

The present general inventive concept relates to an apparatus and method to provide noise measurement in image signals. More particularly, the present general inventive concept relates to an apparatus and method of measuring noise in image signals according to spatial and temporal frequency components, thereby enhancing efficiency of removing the noise.

2. Description of the Related Art

When an image signal-processing device, such as televisions or video tape recorders, is supplied with image signals, it is often the case that a noise is entrained in the image signals. The noise in the image signals typically causes a reduction in the quality of images in video signals. To reduce the noise in the video signals, various noise measurement apparatuses have been developed. An efficiency of removing the noise depends on the accurate noise measurement.

FIG. 1 is a view showing a conventional noise measurement apparatus. Referring to FIG. 1, a noise measurement apparatus comprises an SAD calculator 100, an SAD comparator 102, a first counter 104, a comparator 106, a second counter 108, and a multiplier 110.

The SAD calculator 100 breaks an input image signal into a plurality of blocks (e.g., 175,000 blocks) each of which is configured by pixels, and calculates an SAD (Sum of Absolute Difference) with respect to each block.

The SAD calculated by the SAD calculator 100 is transmitted to the SAD comparator 102. The SAD comparator 102 determines whether the SAD transmitted from the SAD calculator 100 exists between a threshold A and a threshold B. If the SAD is determined to exist between the threshold A and the threshold B, the SAD comparator 102 transmits to the first counter 104 an existence-notifying signal (OK signal) by which a counted value of the first counter 104 is increased.

The first counter 104 is reset by a picture frequency signal Fp once for a picture period. Alternatively, the first counter 104 may be reset once for another period, for example, a field period or multiple fields period. In this case, a proper reset signal has to be applied to the first counter 104.

The SAD calculator 100, the SAD comparator 102, and the first counter 104 receive a clock signal of a sample frequency Fs and are reset by the received Fs. A value counted by the first counter 104 is transmitted to the comparator 106, and the comparator 106 compares the counted value with a predetermined value NE. The predetermined value NE is a preset integer that is experimentally obtained. It is preferable that NE=496, which corresponds to 0.28% of total numbers of the blocks. A result of comparing by the comparator 106 is transmitted to the second counter 108.

The second counter 108 increases and decreases its counted value according to the result obtained by the comparator 106. If the value counted by the first counter 104 is larger than or equal to the NE, the second counter 108 decreases the counted value thereof. On the other hand, if the value counted by the first counter 104 is less than the NE, the second counter 108 increases its counted value. The second counter 108 is reset by the reset signal applied to the first counter 104, i.e., the clock signal of the picture frequency signal Fp. The valued counted by the second counter 108 results in a noise measurement, a low threshold A of the SAD comparator 102, and a high threshold value B which is obtained by the multiplier 110 as a result of multiplying the low threshold A by a value ‘f’.

The value ‘f’ is preferably set to 1.5, and it may be set to a sum of the low threshold A and a fixed offset value. The high threshold B of the SAD comparator 102 depends on the counted value of the second counter 108, and the low threshold A is set to a fixed value such as 0 or a predetermined positive integer.

FIG. 2 is a view showing one example of the SAD calculator 100 of FIG. 1. Referring to FIG. 2, the SAD calculator 100 comprises delayers 200, 204, 208 and 210, an absolute difference calculator 202 and adders 206, 212, and 214.

Pixels of the input image signal are delayed by the delayer 200 as much as one period. At this time, the SAD is calculated by a difference between horizontally neighboring pixels. If the SAD is calculated by a difference between vertically neighboring pixels, the delayer 200 has to be embodied by a line delayer.

The absolute difference calculator 202 calculates an absolute difference between an input value and an output value of the delayer 200. The absolute difference calculated by the absolute difference calculator 202 is transmitted to the delayers 204, 208, and 210 that are sequentially connected to one another.

The adder 206 adds the absolute difference calculated by the absolute difference calculator 202 to the absolute difference firstly delayed by the delayer 204. The adder 212 adds the absolute difference secondly delayed by the delayer 208 to the absolute difference thirdly delayed by the delayer 210. The adder 214 obtains a sum of the value of the adder 206 and the value of the adder 212. The sum obtained by the adder 214 becomes the SAD that is inputted to the SAD comparator 102.

However, when the conventional noise measurement apparatus measures a noise in image signals, the SAD is calculated with respect to a spatial area of the image signals. Therefore, the noise measurement cannot be implemented adaptively to characteristics of the image signals, and thus an error occurs. For example, when the entire image has no plane area, the error may occur in the noise measurement.

### SUMMARY OF THE INVENTION

In order to solve the above and/or other problems, the present general inventive concept provides a noise measurement apparatus which is capable of reducing an error when measuring a noise in an image signal, and a method thereof.

The present general inventive concept also provides is to provide a noise measurement apparatus which is capable of reducing an error when measuring a noise in an image having no plane area.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing a noise measurement apparatus for an image signal comprising: a block average estimation part that breaks a picture of an incoming image signal into at least two blocks and calculates an average brightness value with respect to each block in a sequence; a spatial noise measurement part that calculates at least two first data, each being a sum of differences between the average brightness value transmitted from the block average estimation part and brightness values of respective constituent pixels of the block where the average brightness value is calculated from, and calculates a spatial noise based on the at least two first data; a temporal noise measurement part that calculates at least two second data that indicate a difference between a brightness value of each block of the picture and a brightness value of each block of a delayed picture, and calculates a temporal noise based on the at least two second data; and a noise calculation part that calculates a noise in the image signal based on the spatial noise and the temporal noise.

The foregoing and/or other aspects of the present general inventive concept are also achieved by providing a noise measurement method of an image signal comprising: breaking a picture of an incoming image signal into at least two blocks and calculating an average brightness value with respect to each block in a sequence; calculating at least two first data, each being a sum of differences between the calculated average brightness value and brightness values of respective constituent pixels of the block where the average brightness value is calculated from, and calculating a spatial noise based on the at least two first data; calculating at least two second data that indicate a difference in a brightness value of each block of the picture and a brightness value of each block of a delayed picture, and calculating a temporal noise based on the at least two second data; and calculating a noise on the image signal based on the spatial noise and the temporal noise.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view showing one example of a conventional noise measurement apparatus;

FIG. 2 is a view showing one example of a SAD calculator of FIG. 1;

FIG. 3 is a view showing an image signal used in measuring a noise according to an embodiment of the present general inventive concept;

FIG. 4 is a block diagrams showing a noise measurement apparatus according to an embodiment of the present general inventive concept;

FIGS. 5A and 5B are views showing an interlaced scan method and a progressive scan method to explain operations of the noise measurement apparatus of FIG. 4;

FIG. 6 is a view showing a picture broken into a plurality of blocks; and

FIG. 7 is a view showing a noise measurement apparatus according to another embodiment of the present general inventive concept.

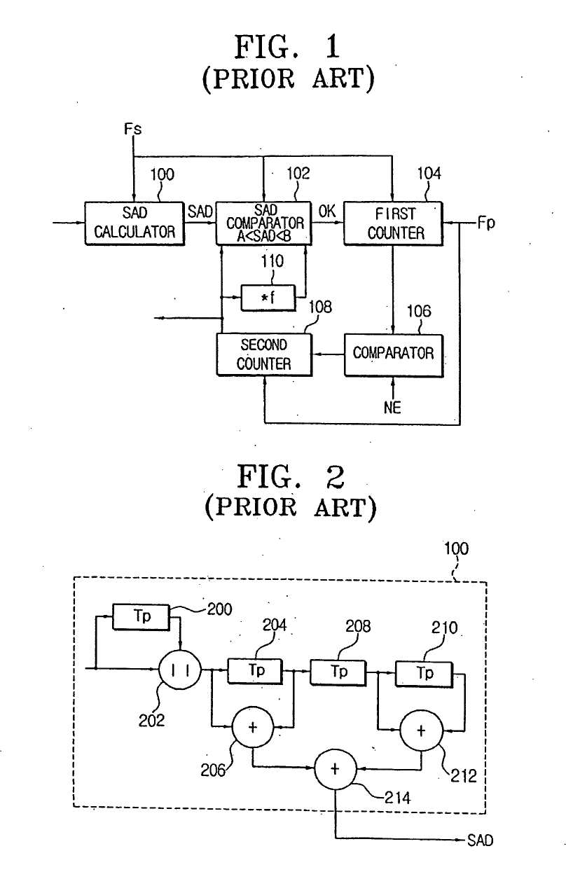

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

The present general inventive concept describes a method of reducing an error of a noise measured by using both a spatial area and a temporal area of an image signal.

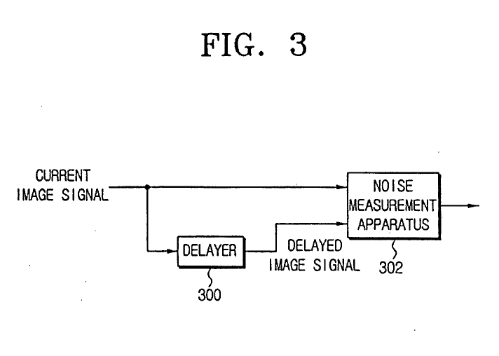

FIG. 3 illustrates an image signal inputted to a noise measurement apparatus 302 according to the present general inventive concept. The noise measurement apparatus 302 is inputted with a current image signal and a one-picture-delayed image signal which is obtained by a delayer 300. Although FIG. 3 depicts the image signal is delayed by the delayer 300, this should not be considered as limiting. That is, the noise measurement apparatus 302 may be inputted with a one-picture-delayed image signal which is obtained by a noise remover, a progressive scan converter or a picture velocity converter.

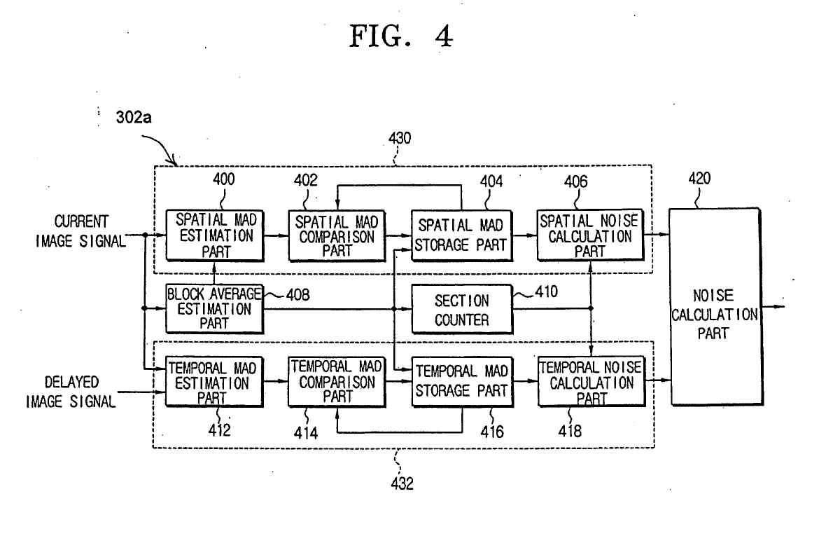

FIG. 4 is a block diagram illustrating one example of a noise measurement apparatus 302a of the noise measurement apparatus 302 of FIG. 3, according to an embodiment of the present general inventive concept. The noise measurement apparatus 302a of FIG. 4 comprises a spatial MAD (Mean Absolute Difference) estimation part 400, a spatial MAD comparison part 402, a spatial MAD storage part 404, a spatial noise calculation part 406, a block average estimation part 408, a section counter 410, a temporal MAD estimation part 412, a temporal MAD comparison part 414, a temporal MAD storage part 416, a temporal noise calculation part 418, and a noise calculation part 420. Although FIG. 4 depicts only particular components to explain an embodiment of the present general inventive concept, the noise measurement apparatus 302a may further comprise other components. The noise measurement apparatus 302a may be used in an image signal processing apparatus.

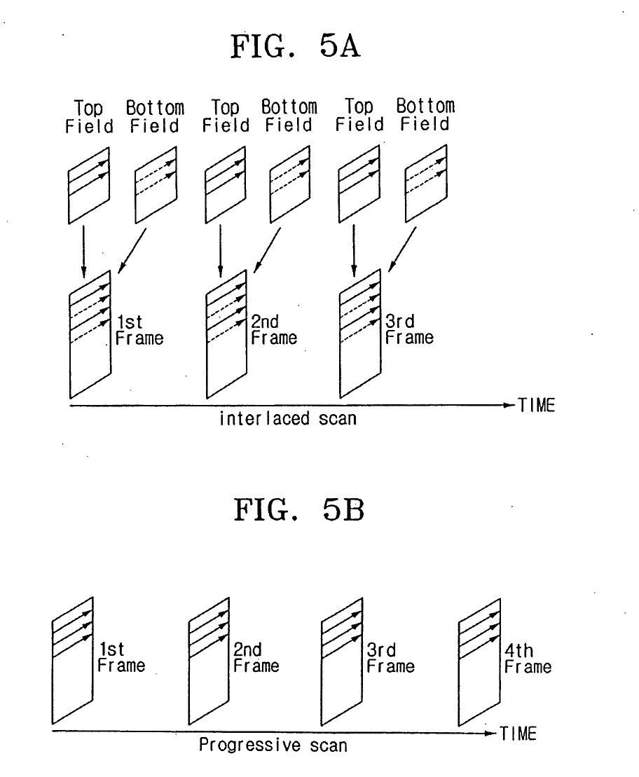

A method of realizing a digital image is divided into an interlaced scan method and a progressive scan method according to a frame configuring method. According to the interlaced scan method as shown in FIG. 5A, a frame is created by scanning two fields line by line and sequentially, and then combining the two fields. More specifically, one field (top field) is scanned with odd lines (illustrated in solid arrows) and the other field (bottom field) is scanned with even lines (illustrated by dotted arrows), and then, by combining the two fields, a frame is created. In contrast with the interlaced scan method, the progressive scan method as shown in FIG. 5B doubles scan lines, thus achieving a high density image and a high quality image, and scans one frame with image signals. According to the interlaced scan method, one field configures a picture of an image signal, and according to the progressive scan method, one frame configures a picture of an image signal.

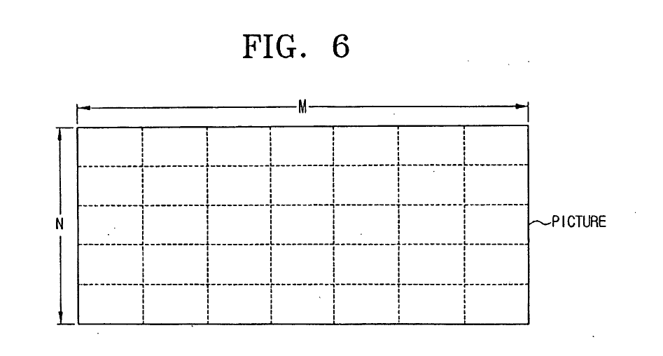

FIG. 6 illustrates one example of a picture broken into a plurality of blocks. Referring to FIG. 6, the picture is broken into M blocks in a horizontal axis direction and N blocks in a vertical axis direction. Accordingly, one picture is broken into M×N blocks. The M and N depend on a user's setting. The user increases the M and N for an accurate noise measurement and decreases the M and N for a reduction of calculation amounts.

The block average estimation part 408 breaks an incoming current image signal (picture) into a predetermined number of blocks and calculates an average brightness value with respect to each block. The block average estimation part 408 breaks a frame or a field of the incoming current image signal into a predetermined number of blocks, each of which has a predetermined size. The predetermined number of blocks are illustrated in FIG. 6.

One block contains m×n pixels, where m indicates a number of pixels existing in a horizontal direction and n indicates a number of pixels existing in a vertical direction. The block average estimation part 408 calculates an average brightness value of each block. That is, the block average estimation part 408 obtains a sum of brightness values of the pixels within each block and calculates the average brightness value of the sum of brightness values by dividing the sum of the brightness values by the total number of pixels m×n.

Hereinafter, a spatial noise measurement unit 430 and a temporal noise measurement unit 432 will now be described.

The block average estimation part 408 performs the above-described operation M×N times in a sequence, thereby estimating block averages with respect to one picture. The block averages estimated by the block average estimation part 408 is transmitted to the spatial MAD estimation part 400, the section counter 410, the spatial MAD storage part 404, and the temporal MAD storage part 416.

The section counter 410 matches the block averages transmitted from the block average estimation part 408 with one of a plurality of sections which correspond to brightness ranges obtained by dividing brightness levels (0 through 255) by, for example, 8, and increases a counted value of the matched section by 1. It is assumed that the block averages estimated by the block average estimation part 408 are from 0 to 255 and the section counter 410 has 8 sections. Table 1 below shows the 8 sections matched with the block averages by the section counter 410.

TABLE 1

| | |
|---|---|
| Section 1 | 0 to 31 |
| Section 2 | 32 to 63 |
| Section 3 | 64 to 95 |
| Section 4 | 96 to 127 |
| Section 5 | 128 to 159 |
| Section 6 | 160 to 191 |
| Section 7 | 192 to 223 |
| Section 8 | 224 to 255 |

As described above, the section counter 410 matches the inputted block averages with one of the above sections, and then increases a counted value of the matched section by 1. Table 2 below shows one example of counted values stored in the section counter 410 with respect to the respective sections.

TABLE 2

| | |
|---|---|
| Section 1 | 0 |
| Section 2 | 2 |
| Section 3 | 3 |
| Section 4 | 3 |
| Section 5 | 3 |
| Section 6 | 2 |
| Section 7 | 1 |
| Section 8 | 0 |

The spatial MAD estimation part 400 obtains a difference between the block average transmitted from the block average estimation part 408 and the brightness value of each pixel configuring the block. The spatial MAD estimation part 400 obtains a sum of the obtained differences and then calculates an average as a special MAD. The operation of the spatial MAD estimation part 400 is identical to that of the SAD calculator 100 of FIG. 2. However, the SAD calculator 100 outputs the sum of differences with respect to the pixels, whereas the spatial MAD estimation part 400 obtains the sum of the differences with respect to the pixels and then outputs the average of the sum. The spatial MAD obtained by the spatial MAD estimation part 400 is expressed by the following equation 1.

$$Spatial MAD = \frac{{\sum }_{i = 0}^{m \times n - 1} \vert \begin{matrix} block average - \\ saturation value of ith pixel\end{matrix} \vert}{m \times n} \qquad [ Equation 1 ]$$

The spatial MAD comparison part 402 compares the spatial MAD transmitted from the spatial MAD estimation part 400 with a spatial MAD transmitted from the spatial MAD storage part 404. The spatial MAD comparison part 402 transmits a smaller spatial MAD to the spatial MAD storage part 404.

The spatial MAD storage part 404 receives the block averages from the block average estimation part 408. The spatial MAD storage part 404 groups the block averages into 8 and stores them as shown in tables 1 and 2. The spatial MAD storage part 404 stores in each section the spatial MAD transmitted from the spatial MAD comparison part 402. Table 3 below shows the spatial MADs stored in the spatial MAD storage part 404 by way of an example.

TABLE 3

| | |
|---|---|
| Section 1 (0 to 31) | |
| Section 2 (32 to 63) | 12 |
| Section 3 (64 to 95) | 24 |
| Section 4 (96 to 127) | 21 |
| Section 5 (128 to 159) | 5 |
| Section 6 (160 to 191) | 4 |
| Section 7 (192 to 223) | 7 |
| Section 8 (224 to 255) | |

The spatial MAD storage part 404 transmits to the spatial MAD comparison part 402 the spatial MADs stored in correspondence to the block averages transmitted from the block average estimation part 408. As one example, if the spatial MAD storage part 404 receives 72 from the block average estimation part 408, it transmits 24 to the spatial MAD comparison part 402. As described above, the spatial MAD comparison part 402 transmits to the spatial storage part 404 a small one of the received spatial MADs.

When the spatial MAD storage part 404 performs an estimation, a comparison, and a storing with respect to one picture, it transmits the table 3 to the spatial noise calculation part 406.

The spatial noise calculation part 406 receives the table 3 from the spatial MAD storage part 404 and also receives the table 2 from the section counter 410. The spatial noise calculation part 406 calculates an average with respect to the spatial MADs based on the table 3. The section having a counted value of 0 is not taken into consideration when the average with respect to the spatial MADs is calculated. That is, the sections 1 and 8 are not considered in calculating the average with respect to the spatial MADs. The spatial noise calculation part 406 calculates the average simply based on the table 3. However the spatial noise calculation part 406 takes a counted value in each section of table 2 into consideration when calculating the average. That is, the average may be calculated by varying a weight according to the counted value of each section. The spatial noise calculation part 406 calculates the average as a spatial noise with respect to the spatial MADs excluding the least spatial MAD and the greatest spatial MAD.

The spatial noise calculation part 406 transmits the calculated spatial noise to the noise calculation part 420.

Hereinbelow, the temporal noise measurement unit 432 is described. An operation of calculating the temporal noise is similar to that of calculating the spatial noise.

The temporal MAD estimation part 412 breaks a current image signal and a delayed image signal into a predetermined number of blocks, respectively. The temporal MAD estimation part 412 calculates a difference between a pixel of a block of the current image signal and a pixel of a block of the delayed image signal, wherein the block of the current image signal and the block of the delayed image signal correspond with each other. A temporal MAD with respect to a block consisting of m×n pixels is obtained by the following equation 2.

$$Temporal MAD = \frac{{\sum }_{i = 0}^{m \times n - 1} \vert \begin{matrix}saturation value of ith pixel \\ of current image signal - \\ saturation value of ith pixel \\ of delayed image signal\end{matrix} \vert}{m \times n} \qquad [ Equation 2 ]$$

The temporal MAD comparison part 414 compares the temporal MAD transmitted from the temporal MAD estimation part 412 with a temporal MAD transmitted from the temporal MAD storage part 416. The temporal MAD comparison part 414 transmits a smaller temporal MAD to the temporal MAD storage part 416.

The temporal MAD storage part 416 is inputted with the block averages from the block average estimation part 408. The temporal MAD storage part 416 divides the block averages into 8 and stores them in each section as shown in tables 1 and 2. The temporal MAD storage part 416 stores in each section the temporal MADs transmitted from the temporal MAD comparison part 414.

The temporal MAD storage part 416 transmits to the temporal MAD comparison part 414 the temporal MADs stored in correspondence with the block averages transmitted from the block average estimation part 408. When the temporal MAD storage part 416 performs estimation, comparison, and storing with respect to one picture, it transmits to the temporal noise calculation part 418 the temporal MADs of the respective sections as shown in the following table 4.

TABLE 4

| | |
|---|---|
| Section 1 (0 to 31) | |
| Section 2 (32 to 63) | 10 |
| Section 3 (64 to 95) | 26 |
| Section 4 (96 to 127 | 22 |
| Section 5 (128 to 159) | 12 |
| Section 6 (160 to 191) | 24 |
| Section 7 (192 to 223) | 12 |
| Section 8 (224 to 255) | |

The temporal noise calculation part 418 receives the table 4 from the temporal MAD storage part 416 and the table 2 from the section counter 410. The temporal noise calculation part 418 calculates an average with respect to the temporal MADs based on table 4. The section having a counted value of 0 is not considered in calculating the average with respect to the temporal MADs. That is, the sections 1 and 8 are not considered in calculating the average with respect to the temporal MADs. The temporal noise calculation part 418 calculates the average simply based on the table 4. However, the temporal noise calculation part 418 may calculate the average by taking the counted values of the sections transmitted from the able 2 into consideration. Also, the temporal noise calculation part 418 may calculate the average as a temporal noise with respect to the temporal MADs excluding the least temporal MAD and the greatest temporal MAD.

The temporal noise calculation part 418 transmits the calculated temporal noise to the noise calculation part 420.

The noise calculation part 420 outputs a smaller one of the spatial noise transmitted from the spatial noise calculation part 406 and the temporal noise transmitted from the temporal noise calculation part 418. Also, the noise calculation part 420 may output an average of the spatial noise transmitted from the spatial noise calculation part 406 and the temporal noise transmitted from the temporal noise calculation part 418. A value output from the noise calculation part 420 means a noise in the current image signal.

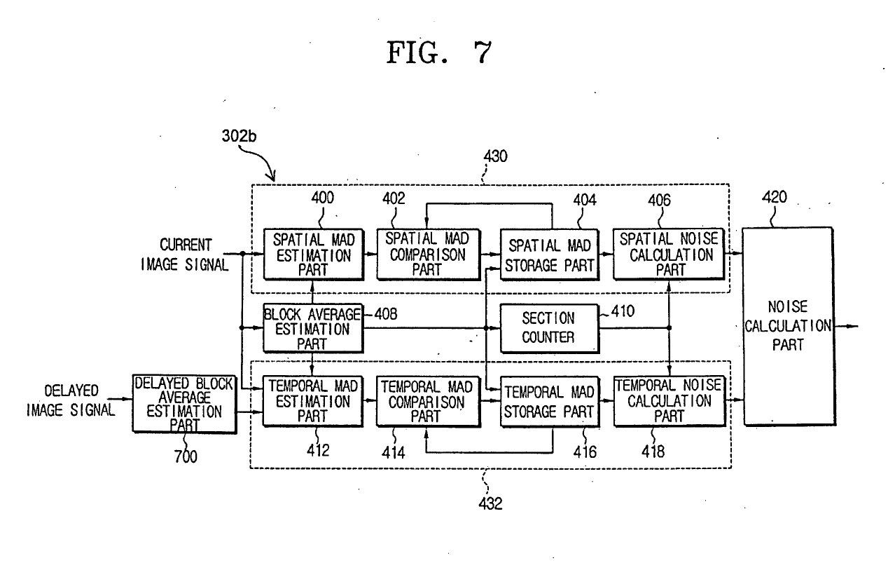

FIG. 7 illustrates another example of a noise measurement apparatus 302b of the noise measurement apparatus 302 of FIG. 3, according to another embodiment of the present general inventive concept. Unlike the case of FIG. 4, a block average with respect to a current image signal and a block average with respect to a delayed image signal are transmitted to a temporal MAD estimation part 412. Operations performed by a delayed block average estimation part 700 are identical to that performed by the block average estimation part 408. The temporal MAD estimation part 412 receives a block average of each block, thereby reducing calculation amount. That is, since the temporal MAD estimation part 412 receives the block average of each block for the comparison, an amount of calculation can be reduced as compared to the temporal MAD estimation part 412 of FIG. 4 which receives the pixels for the comparison.

The present general inventive concept measures the spatial noise and the temporal noise at the same time, thereby reducing an error in noise measurement caused by a conventional apparatus which measures only the spatial noise with respect to the image having no plane area.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A noise measurement apparatus for an image signal, comprising:
a block average estimation part that breaks a picture of an incoming image signal into at least two blocks and calculates an average brightness value with respect to each block in a sequence;
a spatial noise measurement unit that calculates at least two first data, each being a sum of differences between the average brightness value transmitted from the block average estimation part and brightness values of respective constituent pixels of the block from which the average brightness value is calculated, and calculates a spatial noise based on the at least two first data;
a temporal noise measurement unit that calculates at least two second data that indicate a difference between a brightness value of each block of the picture and a brightness value of each block of a delayed picture, and calculates a temporal noise based on the at least two second data; and
a noise calculation part that calculates a noise in the incoming image signal based on the spatial noise and the temporal noise.

2. The noise measurement apparatus as claimed in claim 1, wherein the spatial noise measurement unit comprises:
a spatial MAD estimation part that calculates the at least two first data;
a spatial MAD comparison part that transmits a smaller data between the first data transmitted from the spatial MAD estimation part and a first data transmitted from a spatial MAD storage part to the spatial MAD storage part;
a spatial MAD storage part that transmits to the spatial MAD comparison part the first data corresponding to the average brightness value transmitted from the block average estimation part, and when receiving the block averages of all of blocks of the picture, transmits the at least two first data received from the spatial MAD comparison part; and
a spatial noise calculation part that calculates the spatial noise based on the at least two first data received from the spatial MAD storage part.

3. The noise measurement apparatus as claimed in claim 2, wherein the spatial MAD storage part stores the received average brightness value and the first data corresponding to the average brightness value.

4. The noise measurement apparatus as claimed in claim 2, wherein the spatial MAD storage part divides the averages of brightness values into at least two sections, and transmits to the spatial MAD comparison part the first data of sections corresponding to the received averages of brightness values.

5. The noise measurement apparatus as claimed in claim 4, wherein the spatial noise calculation part calculates an average of the at least two first data and transmits the calculated average to the noise calculation part.

6. The noise measurement apparatus as claimed in claim 4, wherein the spatial noise calculation part calculates an average of the first data excluding the least data and the greatest data and transmits the calculated average to the noise calculating part.

7. The noise measurement apparatus as claimed in claim 2, wherein the temporal noise measurement unit comprises:
a temporal MAD estimation part that calculates the second data;
a temporal MAD comparison part that transmits a smaller one of the second data transmitted from the temporal MAD estimation part and a second data transmitted from a temporal storage part;
a temporal MAD storage part that transmits to the temporal MAD comparison part the second data corresponding to the averages of brightness values transmitted from the block average estimation part, and when receiving the block averages with respect to all of the blocks of the picture, transmits the second data received from the temporal MAD comparison part; and
a temporal noise calculation part that calculates a temporal noise based on the second data received from the temporal MAD storage part.

8. The noise measurement apparatus as claimed in claim 7, wherein the temporal MAD storage part divides the averages of brightness values into at least two sections, and matches the average brightness value with one of the sections.

9. The noise measurement apparatus as claimed in claim 1, wherein the noise calculation part outputs a smaller one between the spatial noise received from the spatial noise measurement unit and the temporal noise received from the temporal noise measurement unit.

10. The noise measurement apparatus as claimed in claim 1, further comprising a section counter that divides the averages of brightness values into at least two sections and increases counted values of the sections corresponding to the averages of brightness value received from the block average estimation part.

11. A noise measurement apparatus for an image signal in an image processing apparatus, comprising:
a block average estimation part to estimate block brightness averages of a plurality of blocks forming a picture in a sequence, each block being formed of a predetermined number of pixels;
a spatial noise measurement unit to calculate a spatial noise based on the estimated values from the block average estimation part and brightness values of each pixel forming the respective block on which the estimated value is received;
a temporal noise measurement unit to calculate a temporal noise base on a relationship between pixels of a block of a current picture and pixels of a block of a delayed picture corresponding with the current picture; and
a noise calculation part to calculate a noise in the picture based on the calculated spatial and temporal noises.

12. The noise measurement apparatus of claim 11, wherein the spatial noise is calculated by obtaining a difference between the block average transmitted from the block average estimation part and the brightness value of each pixel forming the block, obtaining the sum of the obtained differences, calculating an average of the sum, calculating a spatial mean absolute difference (MAD), and comparing the calculated spatial MAD with a stored spatial MAD and calculates an average with respect to the spatial MADs based on a table.

13. The noise measurement apparatus of claim 12, wherein the spatial MAD is calculated by the following equation:
$$Spatial MAD = \frac{{\sum }_{i = 0}^{m \times n - 1} \vert \begin{matrix} block average - \\ saturation value of ith pixel\end{matrix} \vert}{m \times n}$$
wherein m indicates a number of pixels existing in a horizontal direction of the picture and n indicates a number of pixels existing in a vertical direction of the picture.

14. The noise measurement apparatus of claim 12, wherein the temporal noise is calculated by breaking the current picture and the delayed picture into a predetermined number of blocks, calculating a difference between a pixel of the block of the current picture and a pixel of the block of the delayed picture, calculating a temporal mean absolute difference (MAD), comparing the temporal MAD with a stored temporal MAD, and calculating an average with respect to the temporal MADs based on a table.

15. The noise measurement apparatus of claim 14, wherein the temporal MAD is calculated by the following equation:
$$Temporal MAD = \frac{{\sum }_{i = 0}^{m \times n - 1} \vert \begin{matrix}saturation value of ith pixel \\ of current image signal - \\ saturation value of ith pixel \\ of delayed image signal\end{matrix} \vert}{m \times n}$$

16. The noise measurement apparatus of claim 14, wherein the picture is formed of an image signal.

17. A noise measurement method for an image signal, the method comprising:
breaking a picture of an incoming image signal into at least two blocks and calculating an average brightness value with respect to each block in a sequence;
calculating at least two first data, each being a sum of differences between the calculated average brightness value and brightness values of respective constituent pixels of the block where the average brightness value is calculated from, and calculating a spatial noise based on the at least two first data;
calculating at least two second data that indicate a difference a brightness value of each block of the picture and a brightness value of each block of a delayed picture, and calculating a temporal noise based on the at least two second data; and
calculating a noise of the incoming image signal based on the spatial noise and the temporal noise.

18. The noise measurement method as claimed in claim 17, wherein the spatial noise calculation operation comprises:
calculating the at least two first data with respect to each block;
dividing the averages of brightness values into at least two sections, selecting the smallest one of the first data having the average brightness value included in the section, and transmitting the first data to the selected section; and
calculating the spatial noise based on the at least two first data.

19. The noise measurement method as claimed in claim 18, wherein the averages of brightness values are divided into at least two sections, and when the average brightness value included in the section is received, a counted value of the section increases.

20. The noise measurement method as claimed in claim 19, wherein the spatial noise calculation operation calculates an average of the at least two first data.

21. The noise measurement method as claimed in claim 19, wherein the spatial noise calculation operation calculates an average of the first data excluding the least value and the greatest value of the at least two first data.

22. The noise measurement method as claimed in claim 18, wherein the temporal noise calculation operation comprises:
calculating the second data with respect to each block;
dividing the averages of brightness values into at least two sections, selecting the least one of the second data having the average brightness value included in the section, and transmitting the second data with respect to the selected section; and
calculating a temporal noise based on the received second data.

23. The noise measurement method as claimed in claim 17, further comprising outputting a smaller one between the received spatial noise and the received temporal noise.

24. A noise measurement method for an image signal in an image processing apparatus, the method comprising:
calculating an average brightness value for each of a plurality of blocks of a current image signal in a sequence;
obtaining a difference between each block average brightness value and a brightness value of each of a plurality of pixels configuring each block, and calculating a spatial noise of each block based on the obtained differences;
obtaining a sum of the obtained differences and calculating an average;
obtaining a difference between the brightness value of each block of the current image signal and a brightness value of each block of a delayed image signal, and determining a temporal noise based on the obtained differences; and
calculating a noise of the image signal based on the spatial noise and the temporal noise.
